(19) United States
(12) Patent Application Publication
(10) Pub. No.: US 2006/0022898 A1
(43) Pub. Date: Feb. 2, 2006

(54) Light emitting diode driver circuit with current compensation

(75) Inventor: Yen-Wen Chen, Taipei (TW)

Correspondence Address: BACON & THOMAS, PLLC, 625 SLATERS LANE, FOURTH FLOOR, ALEXANDRIA, VA, 22314, US

(73) Assignee: Princeton Technology Corporation, Hsin Tien (TW)

(21) Appl. No.: 10/936,517

(22) Filed: Sep. 9, 2004

(30) Foreign Application Priority Data
Jul. 28, 2004 (TW) 093211911

(51) Int. Cl. G09G 3/14; G09G 3/32; G09G 3/36; G09G 5/00

(52) U.S. Cl. 345/46; 345/214; 345/82; 345/100; 345/204

(57) ABSTRACT

The present invention provides a light emitting diode driver circuit with current compensation. A plurality of LEDs are arranged in matrix form, the panel and the switches have circuit resistance, when plural LEDs in the same column are ON and the current source flows through the circuit resistance, it will cause multiple voltage drops across the circuit resistance. Thus, the voltage of the LEDs and the current source is decreased and the current of the LEDs is decreased, as a result, the brightness of the LEDs will be reduced and become unstable. The present invention copies a set of LED current-source circuit which is additionally provided with an adder circuit, so that the current of the LEDs can be compensated, and thus the brightness of the LED can be maintained.

### BACKGROUND OF THE INVENTION

1. Field of the Invention

The present invention relates to a light emitting diode (LED) driver circuit, and more particularly to a LED driver circuit with current compensation.

2. Description of the Prior Art

A conventional driver circuit for a light emitting diode (LED) display panel is shown in FIG. 1, which partially shows an 8×3 LED matrix. A constant-current source I_{SEG} is connected to eight arrays of LED via the switches SEG1, SEG2, . . . SEG8 respectively. The eight arrays of LED are arranged in three columns and connected to the resistors R1, R2, R3 (which are resistances of the circuit, not real resistors) and the switches COM1, COM2, COM3 respectively, and finally connected to ground.

For example, when the switches COM1, SEG1 and SEG3 are connected in a closed circuit, and other switches are disconnected, current will flow through LED 11 and LED 31 so that LED 11 and LED 31 will be ON, however, the rest LEDs will be OFF.

The more current flows through the LED, the brighter the LED will be. When current flows through several LEDs in a longitudinal column and then flows through the resistors R1, R2 or R3, it will cause multiple voltage drops across the resistors R1, R2 or R3 respectively. Thus, the voltage of the LED and the current source will be decreased more or less, which further leads to current decrease, so that the brightness of the LED will decrease and become unstable.

The present invention has arisen to mitigate and/or obviate the afore-described disadvantages.

### SUMMARY OF THE INVENTION

The primary object of the present invention is to provide a LED driver circuit with current compensation. The present invention copies a set of LED current-source circuit which is additionally provided with an adder circuit, so that the current of the LEDs can be compensated, and thus the brightness of the LED can be maintained.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a schematic diagram for showing a conventional LED driver circuit;

FIG. 2 shows a LED driver circuit with current compensation in accordance with the present invention.

### DETAILED DESCRIPTION OF THE EMBODIMENT

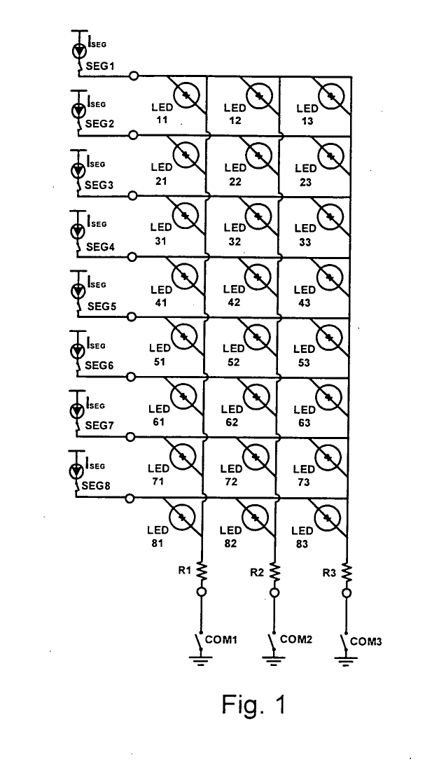

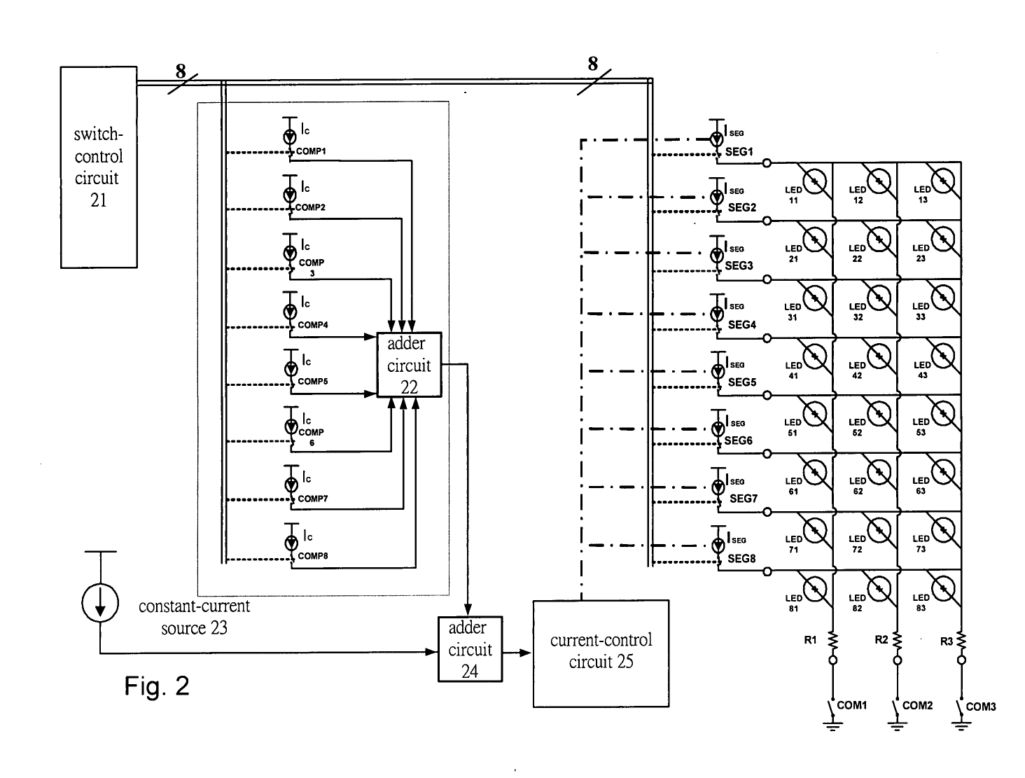

Referring to FIG. 2, the right part of which is the circuit as shown in FIG. 1, and the left part of which shows a new design in accordance with the present invention. The right part of FIG. 2 comprises a circuit including a constant-current source I_{SEG} connected to eight arrays of LED via the switches SEG1, SEG2, . . . SEG8 respectively. The left part of FIG. 2 duplicates the right part of FIG. 1, but the constant-current source uses the name of I_{C}, and is transmitted to an adder circuit 22 via eight switches COMP1, COMP2 . . . COMP8.

A switch-control circuit 21 at the top left corner in FIG. 2 serves to control the switches SEG1, SEG2, . . . SEG8 and make the constant-current source I_{SEG} flows to the eight arrays of LED, which is inputted with control instruction for controlling the ON and OFF of the switches SEG1, SEG2, . . . SEG8 via eight output lines respectively. The eight output lines of the switch-control circuit 21 is further connected to the switches COMP1, COMP2 . . . COMP8 respectively for controlling the ON and OFF of these switches, as shown in FIG. 2. A constant-current source 23 is known as prior art and located at the lower left corner of FIG. 2.

For example, when three output lines of the switch-control circuit 21 are used to connect three of the eight switches SEG1, SEG2, . . . SEG8 in a closed circuit, then three corresponding switches of the eight switches COMP1, COMP2 . . . COMP8 are also connected in a closed circuit. Thus, three corresponding constant-current sources I_{C} of the eight switches COMP1, COMP2 . . . COMP8 are connected to the adder circuit 22 and summed therein, as a result, the output current of the adder circuit 22 and the constant-current source 23 will be summed in a adder circuit 24 and then flows to three corresponding constant-current sources I_{SEG} of the eight switches SEG1, SEG2, . . . SEG8 via a current-control circuit 25.

According to the prior art, when three of the eight switches SEG1, SEG2, . . . SEG8 are connected in a closed circuit and when current flows through the resistors R1, R2 or R3, multiple voltage drops will be caused across the resistors R1, R2 or R3. Thus, the voltage of the LED will be decreased, and the current will be decreased either, so that the brightness of the LED will decrease and become unstable. However, three of the eight switches COMP1, COMP2 . . . COMP8 are inputted with three constant-current sources I_{C} for compensating the current of the constant-current sources I_{SEG} of three closed circuits of the eight switches SEG1, SEG2, . . . SEG8, thus, the brightness of the LED is kept stable without requiring additional logic-operation circuit. The value of the constant-current source I_{C} must be decided by careful calculation and experiment.

The present invention is not only applicable to a conventional LED panel circuit but also to organic LED (OLED) panel circuit. OLED is an organic type LED whose circuit characteristic is identical to the general LED despite its material is different.

The adder circuit 24 in FIG. 2 can be replaced by a subtraction circuit. The current supplied from the constant-current source 23 is the full-load current of eight LEDs. When a certain LED is OFF, a corresponding switch of the COMP1, COMP2 . . . COMP8 will be ON, so that the current is allowed to flow to the subtraction circuit and to be subtracted from the constant-current source 23.

While we have shown and described various embodiments in accordance with the present invention, it should be clear to those skilled in the art that further embodiments may be made without departing from the scope of the present invention.

What is claimed is:

1. A light emitting diode driver circuit with current compensation comprising a constant-current source I_{SEG} which is connected to M arrays of light emitting diode via plural switches SEG1, SEG2, . . . SEGM respectively, wherein the M arrays of light emitting diode are arranged in N columns and connected to plural switches COM1, COM2 . . . COMN respectively and then connected to ground, a switch control circuit includes M lines for controlling the switches SEG1, SEG2, . . . SEGM respectively;
wherein another constant-current source I_{C} flows to a first adder circuit via the switches COMP1, COMP2 . . . COMPM, the M lines of the switch control circuit serve to control the corresponding switches COMP1, COMP2 . . . COMPM by cooperating with the switches SEG1, SEG2, . . . SEGM;
an output current of the first adder circuit and the constant-current source I_{SEG} are summed in a second adder circuit and then transmitted to corresponding light emitting diodes of the switches SEG1, SEG2, . . . SEGM via a current-control circuit.

2. The light emitting diode driver circuit with current compensation as claimed in claim 1, wherein the light emitting diode is an organic light emitting diode (OLED) made of organic material whose circuit characteristic is identical to a conventional LED.

3. The light emitting diode driver circuit with current compensation as claimed in claim 1, wherein the second adder circuit is replaced by a subtraction circuit, a current supplied from the constant-current source I_{SEG} equals to a full-load current value of M pieces of LED, when a certain LED is OFF, a corresponding switch of the COMP1, COMP2 . . . COMPM will be ON, so that current is allowed to flow to the subtraction circuit and to be subtracted from the constant-current source I_{SEG}.
